(19) United States
(12) Patent Application Publication
(10) Pub. No.: US 2018/0171072 A1
(43) Pub. Date: Jun. 21, 2018

(54) METHOD FOR MANUFACTURING A BRANCHED POLY(HYDROXYL ACID)

(71) Applicant: SOLVAY SA, Brussels (BE)

(72) Inventors: Gururajan PADMANABAN, Vadodara, Gujarat (IN); Sanjay, Gurbasappa CHARATI, Lyons (FR); Ketan MAKWANA, Vadodara, Gujarat (IN); Dipanjan SAHA, Vadodara, Gujarat (IN); Manali RAJESHIRKE, Vadodara (IN)

(21) Appl. No.: 15/570,745

(22) PCT Filed: Apr. 29, 2015
(86) PCT No.: PCT/EP2015/059299

§ 371 Date: Oct. 30, 2017

(51) Int. Cl. C08G 63/60; C08G 63/672; C08G 63/80

(52) U.S. Cl. CPC C08G 63/60; C08G 63/80; C08G 63/672

(57) ABSTRACT

The invention pertains to an improved method for synthesizing a branched poly(hydroxyl acid) polymer comprising effecting polycondensation reaction of a monomer mixture comprising: (i) at least one hydroxyl acid having only one hydroxyl group and only one carboxylic acid group [hydroxyacid (A)]; (ii) at least one polyol comprising at least three hydroxyl groups and being free from carboxylic acid group [polyol (H)]; (iii) at least one polyacid comprising at least three carboxylic acid groups and being free from hydroxyl groups [polyacid (O)]; and (iv) at least one carboxylic acid having one or two carboxylic acid groups and being free from hydroxyl group [acid (C)], wherein the amount of said acid (C) is such that the number of carboxylic acid groups thereof is comprised between 0.0001 to 0.010% with respect to the number of hydroxyl groups of hydroxyacid (A).

### CROSS-REFERENCE TO RELATED APPLICATION

This application claims priority to Indian provisional application No. IN 1642/MUM/2014 filed May 14, 2014, the whole content of this application being incorporated herein by reference for all purposes.

### TECHNICAL FIELD

The present invention relates to a method for synthesizing a branched poly(hydroxyl acid) by polycondensation, to the poly(hydroxyl acid) obtained there from, and to the use of this latter for the manufacture of films.

### BACKGROUND ART

Hydroxyl acids may be polycondensed in order to form polymers and some of them (glycolic acid (GA), lactic acid (LA), etc.) have been the subject of a resurgence of interest in recent years due to their bio-sourced nature.

The conventional synthesis of polyglycolide (PGA) adopts the same philosophy as the synthesis of polylactide. Firstly, a polycondensation of glycolic acid is carried out in order to obtain a low molecular weight oligomer. Then, at high temperature and low pressure, this oligomer is depolymerized with a view to distilling mainly the cyclic diester, glycolide. A relatively large number of purification steps follow in order to obtain an ultrapure (>99.90%) glycolide, which will then be subjected to a ring-opening polymerization (in accordance with a procedure similar to the polymerization of the caprolactone monomer, for example). The polymer obtained is linear and has a high molecular weight. Its cost price is high due to the cost of the depolymerization reaction and of the purification of the glycolide.

Hence, techniques for direct polycondensation of hydroxyl acids have been proposed, as alternative to above mentioned burdensome techniques.

While these techniques enables the use of low cost hydroxyl acid reactants, they generally suffer from low molecular weight materials obtainable there from, because of equilibration of chain lengths after a certain time of propagation and/or because of a decrease of molecular weight due to certain back-biting side-reactions at the —OH end groups. Such reactions can be mainly schematized as below detailed.

According to a first mechanism, back-biting might lead to the formation of macro-cycles from a growing chain possessing a terminal —OH group, hence providing a considerably shorter PGA macromolecule with an —OH end group, and a low molecular weight macrocycle.

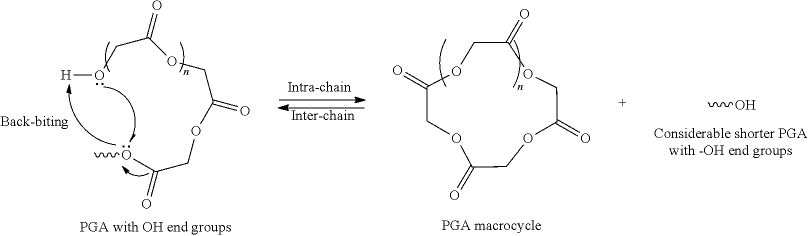

Similar depolymerisation mechanism might lead to the formation of glycolide, by backbiting on the next unit:

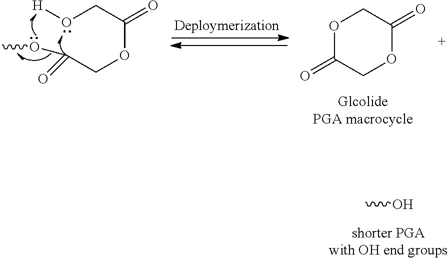

Solutions for obtaining polymer structures from hydroxyl acids of higher molecular weight/viscosity were hence developed based on the addition/incorporation of chain extenders/branching agents.

Hence, US 2012027973 (SOLVAY SA) Feb. 2, 2012 discloses a process for manufacturing a polymer by polycondensation of a hydroxy acid, said polymer comprising at least 80% by weight of units that correspond to the hydroxy acid, according to which at least one polyfunctional reactant capable of giving rise to the formation of a three-dimensional polymer network is mixed with the hydroxy acid, and according to which the mixture is subjected to temperature and pressure conditions and for a duration which are all suitable for giving rise to the formation of the network. Among said polyfunctional reactants, mention is made of epoxy silanes, polyepoxides, and mixtures of at least one polyol and at least one polyacid, of which at least one of (preferably both) the polyol and the polyacid comprise(s) three functionalities.

Still, CN 1563138 (TONGJI UNIVERISTY (CHINA)) Jan. 12, 2005 is directed to a method for manufacturing highly branched polyhydroxyacid polymer (in particular polylactic acid polymer) using a combination of chain extenders comprising 2 or more functional groups, and more particularly chain extenders of type A, having groups able to react with hydroxyl radicals, and chain extenders of type B, having groups able to react with carboxylic acids.

Among chain extenders of type A, mention is notably made of dicarboxylic acids—including notably adipic acid (C6), sebacic acid (C10), undecanoic acid (C11), dodecanoic acid (C12), tridecanoic acid (C13), tetradecanoic acid (C14), pentadecanoic acid (C15)—and of polycarboxylic acid (or derivatives thereof)—including notably pyromellitic acid anhydride and EDTA (ethylenediaminetetraacetic acid), (both having 4 carboxylic groups).

Among chain extenders of type B, mention is notably made of polyols, including e.g. pentaerythritol (having 4 OH groups) and sorbitol (having 6 OH groups).

Still, CN 101585911 (UNIVERSITY OF BEIJING CHEMICAL (CHINA)) Nov. 25, 2009 discloses a method for manufacturing branched or micro-crosslinked polylactic acid, by polymerization of lactic acid in the presence of comonomers, and accurately controlling average functionality of the monomers' mixture for achieving high molecular weight. The comonomers are selected in three classes, i.e.:

(i) mono- or polyacids, among which is mention made of terephthalic acid, isophthalic acid, phthalic acid, 1,4,5,8-naphthalene tetracarboxylic acid, EDTA, 3,4,3′,4′-benzophenone tetracarboxylic acid, malonic acid, adipic acid, sebacic acid, undecandioic acid, and dodecanedioic acid; (ii) mono- or polyols, among which is mention made of ethylene glycol, propylene glycol, 1,3-butanediol, 1,4-butanediol, 2,3-pentanediol, neopentylene glycol, hexanediol, 1,10-decanediol, octadecanediol, glycerol, sorbitol, polyethylene glycol, polytetramethylene glycol, and pentaerythritol; and

(iii) multifunctional hydroxyacids, among which is mention made of dihydroxymethyl propionic acid, citric acid, malic acid, and tartaric acid.

LI, Lei, et al. Direct synthesis of star-branched polylactic acid by melt polycondensation. Suliao Gongye. 2008, vol. 36, no. 3, p. 27-30. discloses the manufacture of a star-branched polylactic by melt polycondensation, with a hydroxyacid, namely L-lactic acid (LLA) as raw material, pentaerythritol as branching agent, and SnCl₂ and p-toluenesulfonic acid (TSA) as catalysts.

Nevertheless, there is a continuous need in the art for developing branched poly(hydroxyl acids) which can be manufactured in a more effective manner for delivering high molecular weight and high viscosity within reasonable reaction times.

### SUMMARY OF INVENTION

The Applicant has now found that it is possible to effectively manufacture high molecular weight/high viscosity branched poly(hydroxyl acid) polymers by using a well-determined combination of reactants/chain extenders.

Hence, the invention pertains to a method for synthesizing a branched poly(hydroxyl acid) polymer comprising effecting polycondensation reaction of a monomer mixture comprising:

(i) at least one hydroxyl acid having only one hydroxyl group and only one carboxylic acid group [hydroxyacid (A)];

(ii) at least one polyol comprising at least three hydroxyl groups and being free from carboxylic acid group [polyol (H)];

(iii) at least one polyacid comprising at least three carboxylic acid groups and being free from hydroxyl groups [polyacid (O)]; and

(iv) at least one carboxylic acid having one or two carboxylic acid groups and being free from hydroxyl group [acid (C)], wherein the amount of said acid (C) is such that the number of carboxylic acid groups thereof is comprised between 0.0001 to 0.010% with respect to the number of hydroxyl groups of hydroxyacid (A).

Without being bound by this theory, the Applicant is of the opinion that the addition of the acid (C), as above detailed, substantially contributes to decrease the amount of free hydroxyl group in the growing chain, so as to inhibit the back-biting phenomena, as above detailed, which are responsible for depolymerisation, and formation of low viscosity materials.

The present invention may be applied to all hydroxyl acids capable of polycondensing, i.e. of forming a macromolecule by condensation (chain addition of monomers with removal of water). In general, hydroxyacids (A) that have a primary alcohol are preferred as they are more reactive. The method, as above detailed, gave good results, in particular, when the hydroxyacid (A) is selected from the group consisting of glycolic acid (GA), lactic acid (LA), and mixtures thereof. Glycolic acid (GA) is very particularly preferred. In one variant of the present process, the hydroxyacid (A) is bio-sourced, that is to say derived from a natural and renewable raw material, as opposed to a fossil raw material. The use of bio-sourced hydroxyacids (A) allows the synthesis of “green” polymers, that is to say polymers synthesized from renewable raw material.

The choice of polyol (H) is not particularly limited. Polyol (H) can be selected from the group consisting of:
triols, in particularly selected from the group consisting of glycerol, trimethylolpropane, trimethylolbutane, 2,3-di(2′-hydroxyethyl)-cyclohexan-1-ol, hexane-1,2,6-triol, 1,1,1-tris(hydroxymethyl)ethane, 3-(2′-hydroxyethoxy)propane-1,2-diol, 3-(2′-hydroxypropoxy)-propane-1,2-diol, 2-(2′-hydroxyethoxy)-hexane-1,2-diol, 6-(2′hydroxypropoxy)-hexane-1,2-diol, 1,1,1-tris-[(2′-hydroxyethoxy)-methylethane, 1,1,1-tris-[(2′-hydroxypropoxy)-methyl-propane, 1,1,1-tris-(4′-hydroxyphenyl)ethane, 1,1,1-tris-(hydroxyphenyl)-propane, 1,1,5-tris-(hydroxyphenyl)-3-methylpentane, trimethylolpropane ethoxylate, trimethylolpropane propoxylate, tris(hydroxymethyl)aminomethane;
tetraols, in particularly selected from the group consisting of diglycerol, di(trimethylolpropane), pentaerythritol, 1,1,4-tris-(dihydroxyphenyl)-butane;
polyols comprising 5 hydroxyl groups, in particular triglycerol;
polyols comprising 6 hydroxyl groups, in particular dipentaerythritol; and
polyols comprising 8 hydroxyl groups, in particular tripentaerythritol.

Preferred polyols (H) are triols (in particular trimethylolpropane) and tetraols (in particular pentaerythritol), as above detailed, more particularly tetraols. A polyol (H) which has been found to provide particularly good results within the frame of the present invention is trimethylolpropane.

The polyol (H) is used in amount of at least 0.1, preferably at least 0.25, more preferably at least 0.5 mmol of polyol (H) per mol of hydroxyacid (A) and/or at most 50, preferably at most 25, more preferably at most 10 mmol of polyol (H) per mol of hydroxyacid (A).

An amount of polyol (H) of from 0.5 to 5 mmol of polyol (H) per mol of hydroxyacid (A) has been found particularly useful according to the preferred embodiments of the present invention.

The polyacid (O) can comprise three carboxylic acid groups or more than three carboxylic acid groups, in particular four carboxylic acid groups. Polyacid (O) can be selected among polycarboxylic aliphatic acids, polycarboxylic cycloaliphatic acids and polycarboxylic aromatic acids.

Examples of polycarboxylic aliphatic acids are:
propane 1,2,3-tricarboxylic acid (also known as tricarballylic acid);
ethane-1,1,2,2 tetracarboxylic acid;
butane-1,2,3,4 tetracarboxylic acid;
pentane-1,2,4,5-tetracarboxylic acid.

Among them, butane-1,2,3,4 tetracarboxylic acid is preferred.

Examples of polycarboxylic cycloaliphatic acids are:
1,2,3,4-cyclobutane tetracarboxylic acid;
2,2,6,6-tetra-(carboxyethyl)cyclohexanone;
(+)-(18-crown-6)-2,3,11,12-tetracarboxylic acid;
cyclopentane-1,2,3,4 tetracarboxylic acid;
cyclohexane-1,2,4,5 tetracarboxylic acid;
cyclohexane-2,3,5,6 tetracarboxylic acid;
3-ethylcyclohexane-1,2,4,5 tetracarboxylic acid;
1-methyl-3-ethyl cyclohexane-3-(1,2)5,6 tetracarboxylic acid;
1-ethyl cyclohexane-1-(1,2),3,4 tetracarboxylic acid;
1-propylcyclohexane-1-(2,3),3,4 tetracarboxylic acid;
1,3-dipropylcyclohexane-1-(2,3),3-(2,3) tetracarboxylic acid;
dicyclohexyl-3,4,3′,4′ tetracarboxylic acid.

Examples of polycarboxylic aromatic acids are:
pyromellitic acid (1,2,4,5-benzene tetracarboxylic acid);
trimesic acid (1,3,5-benzene tricarboxylic acid);
trimellitic acid (1,3,4-benzene tricarboxylic acid);
benzophenone-3,3′,4,4′-tetracarboxylic acid;
tetrahydrofuran-2,3,4,5-tetracarboxylic acid;
4,4′-(hexafluoroisopropylidene)diphthalic acid;
4,4′-oxydiphthalic acid anhydride;
4,4′-(4,4′-isopropylidenediphenoxy)bis(phthalic acid);
3,3′,4,4′-biphenyl tetracarboxylic acid;
2,3,3′,4′-biphenyl tetracarboxylic acid;
2,2′,3,3′-biphenyl tetracarboxylic acid;
1,2,5,6-naphthalene tetracarboxylic acid;
2,3,6,7-naphthalene tetracarboxylic acid;
perylene-3,4,9,10 tetracarboxylic acid;
propane 2,2-bis(3,4-dicarboxyphenyl) acid;
ethane 1,1-bis(2,3-dicarboxyphenyl) acid;
ethane 1,1-bis(3,4-dicarboxyphenyl) acid;
phenanthrene-1,8,9,10-tetracarboxylic acid;
tetrahydrofuran-2,3,4,5-tetracarboxylic acid;
3,3′,4,4′-benzophenone tetracarboxylique acid;
2,2′,3,3′-benzophenone tetracarboxylic acid;
2,3,5,6-pyridine tetracarboxylic acid;
3,3′,4,4′-tetraphenylsilane tetracarboxylic acid;
2,2′-bis-(3,4-bicarboxyphenyl) hexafluoropropane tetracarboxylic acid;
2,2-bis(3,4-dicarboxyphenyl) sulfonic acid;
4,4′-(hexafluoroisopropylidene) diphthalic acid;
3,3′,4,4′-diphenylsulfone tetracarboxylic acid;
ethyleneglycol bistrimellitic acid;
hydroquinone diphthalique acid;
pyrazine-2,3,5,6-tetracarboxylic acid;
thiophene-2,3,4,5-tetracarboxylic acid.

Polyacids (O) which have been found to provide particularly good results within the frame of the present invention are tricarballylic acid, 1,2,4,5-benzene tetracarboxylic acid and butane-1,2,3,4 tetracarboxylic acid, with tricarballylic acid being particularly preferred.

The polyacids (O) is used in amount of at least 0.1, preferably at least 0.25, more preferably at least 0.5 mmol of polyacid (O) per mol of hydroxyacid (A) and/or at most 50, preferably at most 25, more preferably at most 10 mmol of polyacids (O) per mol of hydroxyacid (A).

An amount of polyacid (O) of from 0.5 to 5 mmol of polyacid (O) per mol of hydroxyacid (A) has been found particularly useful according to the preferred embodiments of the present invention.

Generally, the amount of polyacid (O) and of polyol (H), when expressed in moles per mole of hydroxyacid (A), are substantially similar, and the molar ratio polyacid (O):polyol (H) is in the range 1.5:1 to 0.5:1; according to certain embodiments, this molar ratio is preferably of 1.25:1 to 0.75:1, more preferably of 1.10:1 to 0.9:1.

As said the monomer mixture comprises at least one carboxylic acid having one or two carboxylic acid groups and being free from hydroxyl group [acid (C)] in the above defined amount.

The amount of said acid (C) is such that the number of carboxylic acid groups thereof is comprised between 0.0001 to 0.010% with respect to the number of hydroxyl groups of hydroxyacid (A). Preferably said amount is such that the number of carboxylic acid group of said acid (C) is of at least 0.0005%, preferably at least 0.001% with respect to the number of hydroxyl groups of hydroxyacid (A) and/or at most 0.010%, preferably at most 0.008%, most preferably at most 0.007%, even more preferably at most 0.006% with respect to the number of hydroxyl groups of hydroxyacid (A).

The choice of the acid (C) is not particularly limited; both monoacids having only one carboxylic group and diacids having two carboxylic groups can be used. It is generally understood that better results are obtained with long chain acids, i.e. acids (C) wherein the total number of carbon atoms is at least 4, preferably at least 5 more preferably at least 6.

Generally the acid (C) possesses from 4 to 36 carbon atoms, preferably from 6 to 24 carbon atoms.

The acid (C) can comprise unsaturated double bonds in its hydrocarbon chain; the acid (C) is nevertheless preferably an aliphatic acid, that is to say an acid of any of formulae below:

R_{Hm}—COOH (formula C-1)

HOOC—R_{Hd}—COOH (formula C-2)

wherein R_{Hm} is a monovalent aliphatic group having at least 3 carbon atoms; and wherein R_{Hd} is a divalent aliphatic group having at least 2 carbon atoms.

Among acids (C) of monoacid type which can be advantageously used in the process of the invention, mention can be notably made of caprylic acid [CH₃(CH₂)₆COOH], capric acid [CH₃(CH₂)₈COOH], undecanoic acid [H₃C—(CH₂)₉—COOH], dodecanoic or lauric acid [H₃C—(CH₂)₁₀—COOH], tridecanoic acid [H₃C—(CH₂)₁₁—COOH], tetradecanoic or myristic acid [H₃C—(CH₂)₁₂—COOH], pentadecanoic acid [H₃C—(CH₂)₁₃—COOH], hexadecanoic or palmitic acid [H₃C—(CH₂)₁₄—COOH], octadecanoic or stearic acid [H₃C—(CH₂)₁₆—COOH], arachidic acid [H₃C—(CH₂)₁₈—COOH], and behenic acid [H₃C—(CH₂)₂₀—COOH].

Among acids (C) of diacid type which can be advantageously used in the process of the invention, mention can be notably made of succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂—CH₂—COOH], pimelic acid [HOOC—(CH₂)₆—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecandioic acid [HOOC—(CH₂)₁₀—COOH], tetradecandioic acid [HOOC—(CH₂)₁₁—COOH], octadecandioic acid [HOOC—(CH₂)₁₆—COOH].

An acid (C) which has been show to provide particularly good results is stearic acid, which is hence particularly preferred.

In the method of the present invention, a polycondensation catalyst may optionally be added to the monomer mixture. Such a catalyst is usually added in an amount of about 0.01 to 2 mol %, in particular of about 0.1 to 1 mol % with respect to the total moles of the monomers of the monomer mixtures. Such polycondensation catalysts are well known to a person skilled in the art and may be selected, for example, from tin (II) chloride, stannous octoate, zinc acetate, zinc lactate and methanesulphonic acid, methanesulphonic acid being preferred.

In the method of the present invention, an antioxidant may optionally be added to the reaction medium. Preferably, such an antioxidant is added between the hydroxy acid polycondensation step and the SPC step. Such an antioxidant is typically added in an amount of about 0.01 to 1% by weight, in particular of about 0.1 to 0.5% by weight of the monomer mixture. Such antioxidants are well known to a person skilled in the art and may be selected, for example, from hindered phenols and hindered phosphites. Bis(2,4-di-t-butylphenyl)pentaerythritol diphosphite sold under the name ULTRANOX 626® by CHEMTURA, bis(2,6-di-t-butyl-4-methylphenyl)pentaerythritol diphosphite sold under the name ADK STAB PEP 36® by ADEKA PALMAROLE, and those sold under the name DOVERPHOS® are particularly preferred.

Preferably, the polycondensation reaction is carried out at least partly at a temperature that is high enough so that the reaction takes place in a reasonable time, but that is not too high, in order to avoid degradation (and the associated coloration problems). The duration of the polycondensation reaction is not critical and may be of about 2 to 500 h, most often of about 5 to 250 h, depending on the temperature. In practice, good results have been obtained with glycolic acid and lactic acid at a temperature between 160 and 240° C. Such temperatures are within their melting/crystallization range so that, during the reaction, the crystallization of the polymer obtained may happen.

In a first variant of the present process, once the polycondensation temperature is reached, it is kept as constant as possible throughout the whole of the polycondensation step, which corresponds to a single temperature plateau. According to the present invention, the expression “temperature plateau” means that the temperature is kept substantially constant for at least 5 minutes.

In a second variant, the temperature profile during the polycondensation step may be such that it includes more than one temperature plateau. Preferably, the various temperature plateaus are between 160 and 240° C. In particular, for LA, the various temperature plateaus are advantageously within the range of 170 to 230° C., preferably from 180 to 210° C. For GA, the various temperature plateaus are advantageously above 180° C. and below 240° C., in particular within the range of 190 to 230° C. In this second variant, the temperature difference between the various plateaus may vary from 5 to 30° C., in particular may be of about 10 to 20° C.

In another variant of the present process, that can possibly be combined with the two preceding variants, the polycondensation step may be followed by or end in a plateau at a lower temperature, in particular at a temperature of 10 to 70° C. below the temperature of the highest temperature plateau reached during the polycondensation step, for example at a temperature of about 150 to 190° C., preferably of 160 to 180° C. In this third variant, the lowest temperature plateau is generally maintained for 1 to 24 h.

Preferably, the polycondensation reaction takes place under vacuum in order to evaporate the water of reaction and prevent the latter from hydrolyzing the polymer chains being formed. Very particularly preferably, polycondensation reaction is initiated at atmospheric pressure and the vacuum is applied gradually until a pressure of the order of a few mbar, in particular less than 10 mbar, for example from 2 to 8 mbar, is achieved. The SSP step is typically carried out at a pressure of about 0.01 to 10 mbar, in particular of 0.05 to 5 mbar, for example of about 0.1 mbar.

The polycondensation reaction generally includes a first step of polymerization in the molten state and a second step of solid state polymerization (SSP).

In the first step, the temperature is selected so as to maintain the monomer mixture and, with the progress of the reaction, the formed polymer, in the molten state.

Generally, the first step of polymerization in the molten state is accomplished under stirring, by maintaining the reaction mixture at temperatures ranging from 160 and 240° C.; the temperature may be kept constant during this first step, or can be varied and maintained at more than one temperature plateau. According to the present invention, the expression “temperature plateau” means that the temperature is kept substantially constant for at least 5 minutes.

In the method of the present invention, a milling step is advantageously carried out between the first step of polymerization in the molten state and the second step of solid state polymerization. Such a milling step may be carried out by any means known to a person skilled in the art, for example by milling in a high-speed grinder or in a rotary mill such as the Pulverisette® from FRITSCH. In one variant, a granulation step may be carried out at the end of the melt phase polycondensation in order to carry out the SSP step on granules. This granulation may especially be carried out at the outlet of the reactor on rods cooled in an air stream then introduced into a granulator. Such a granulation or milling is advantageous since it increases the surface area of the solid resulting from the polycondensation step, which allows an easier evaporation of the residual water present in the medium. Furthermore, the milled or granulated product is easier to handle.

The SSP step may take place by exposing the reaction mixture in the solid state, typically under vacuum, for one or more hours or even several days, at a temperature above the glass transition temperature of the said branched poly(hydroxyl acid) polymer, but below its melting/crystallization temperature. Typically, such a SSP step may be carried out at a temperature of 140 to 240° C., in particular of 150 to 230° C., for example at around 170-220° C. and at a pressure below 10 mbar. Depending on the nature of the hydroxyacid (A), on the nature of the reactant(s), on their proportions and on the duration, on the temperature and on the pressure during the overall polycondensation step, the duration of the SSP step may be a few hours to 1 week, in particular from 6 to 200 h, for example of about 10 to 150 h. It should be noted that a too high temperature during the SSP step may also result in a coloration due to the thermal degradation of the polymer. A long duration does not, on the other hand, have a negative influence on the polymer obtained.

The invention further pertains to a branched poly(hydroxyl acid) polymer comprising repeat units and moieties derived from (i) at least one hydroxyl acid having only one hydroxyl group and only one carboxylic acid group [hydroxyacid (A)];

(ii) at least one polyol comprising at least three hydroxyl groups and being free from carboxylic acid group [polyol (H)];

(iii) at least one polyacid comprising at least three carboxylic acid groups and being free from hydroxyl groups [polyacid (O)]; and

(iv) at least one carboxylic acid having one or two carboxylic acid groups and being free from hydroxyl group [acid (C)],

wherein the amount of moieties derived from said acid (C) is such that the number of carboxylic acid derivative groups thereof is comprised between 0.0001 to 0.015% with respect to the number of hydroxyl derivative groups of hydroxyacid (A).

Properties and amounts of hydroxyacid (A), the polyol (H), polyacid (O) and acid (C) are as above detailed.

This branched poly(hydroxyl acid) polymer has a particularly advantageous molten rheology behaviour which makes it particularly easy to be processed in the molten state, e.g. under the form of films.

Should the disclosure of any patents, patent applications, and publications which are incorporated herein by reference conflict with the description of the present application to the extent that it may render a term unclear, the present description shall take precedence.

The invention will be now be described in more detail with reference to the following examples, whose purpose is merely illustrative and not intended to limit the scope of the invention.

### Determination of Melt Viscosity

Melt viscosity of samples was determined using a parallel plate rheometer according to ASTM D4440-08, at a temperature of 250° C. Melt viscosities at 1 sec⁻¹ and 100 sec⁻¹ are summarized in Table 1; values of storage modulus G′ and loss modulus G″, and their ratio, as well as values of melt viscosity at low and high frequency, and their ratio (also known as shear thinning) at 1 sec⁻¹ are summarized in Table 2. The instrument used was a 25 mm diameter parallel plate rheometer available as DHR3 from TA Instruments.

### Preparation of the Polymer PGA2800-100 (Run 1)

1 L Kettle equipped with heater, condenser, temperature sensor and, mechanical stirrer was charged with 1000 g glycolic acid (GA; 13.149 mole, taken as 1.0000 mol basis), 3.28 g of tricarballylic acid (TCA; 0.0186 mole, 0.0014 mol per mol of GA), 2.47 g of trimethylolpropane (TMP; 0.0180 mole, 0.0014 mol per mol of GA), 0.1 g of stearic acid (SA; 100 ppm, 0.000352 mole, 0.000027 mol per mol of GA), 3.02 g of methanesulfonic acid (MSA; 0.0314 mole, 0.0024 mol per mol of GA), and 0.05 g of Doverphos (50 ppm). The reaction mass was heated under a steady nitrogen flow to melt glycolic acid and continued to heat gradually with mechanical stirring until all the solid melted. When the temperature reached 100° C., nitrogen flow was increased and a reduced pressure of 250-300 Torr was maintained. At this inert atmosphere of reduced pressure filled with nitrogen, the temperature of the reaction was raised to 110° C. to remove water. Water removal was continued by gradually raising the temperature to 190° C. and reducing the pressure 100 Torr. The reaction mass was allowed to stand at this temperature and pressure until it solidified. Then, the pressure was further reduced to 20 Torr and the reaction mass was heated gradually to melt the solid mass. It melted at about 230° C., after which it was allowed to stand at molten state for 40-50 minutes under reduced pressure and then cooled to 190° C. to solidify. After about 2 hours at 190° C., the heating was stopped and the reaction mass was allowed to cool to room temperature under a steady flow of nitrogen at atmospheric pressure. Upon cooling to room temperature, the hard monolithic PGA mass was taken out and weighed. Crude yield: 710 g (˜93%). It was then crushed into small pieces using a hammer, and powdered into small particles with less than 1 mm diameter using a high-speed grinder and a 1 mm sieve. The resultant polymer was transferred into a round-bottom flask and attached into a rotary evaporator system for uniform mixing. It was polymerized in the solid state using an oil bath maintained at 215° C. The heating was stopped periodically and the small quantity of the polymer was carefully taken out to analyze the melt viscosity using a parallel plate rheometer at different times of solid state polymerization (SSP). After achieving the desired melt viscosity, the heating was stopped and the SSP was arrested.

### Preparation of the Polymer PGA2400-100 (Run 2)

Poly(glycolic acid) PGA2400-100 was prepared similar to the procedure described for PGA2800-100, except that the following amounts of tricarballylic acid and trimethylolpropane monomers were used: TCA (2.81 g; 0.0159 mole, 0.0012 mol per mol of GA) and TMP (2.117 g; 0.0159 mole, 0.0012 mol per mol of GA).

### Preparation of the Polymer PGA2000-100 (Run 3)

Poly(glycolic acid) PGA2000-100 was prepared similar to the procedure described for PGA2800-100, except that the following amounts of tricarballylic acid and trimethylolpropane monomers were used: TCA (2.342 g; 0.0133 mole, 0.0010 mol per mol of GA) and TMP (1.764 g; 0.0133 mole, 0.0010 mol per mol of GA).

### Preparation of the Polymer PGA1600-100 (Run 4)

Poly(glycolic acid) PGA1600-100 was prepared similar to the procedure described for PGA2800-100, except that the following amounts of tricarballylic acid and trimethylolpropane monomers were used: TCA (1.873 g; 0.01064 mole, 0.0008 mol per mol of GA) and TMP (1.4112 g; 0.01064 mole, 0.0008 mol per mol of GA).

### Preparation of the Polymer PGA2800-0 (Run 5C)

Poly(glycolic acid) PGA2800-0 was prepared similar to the procedure described for PGA2800-0, except that no stearic acid was used.

### Preparation of the Polymer PGA2800-50 (Run 6)

Poly(glycolic acid) PGA2800-50 was prepared similar to the procedure described for PGA2800-100, except that 0.05 g of stearic acid (SA; 50 ppm, 0.000176 mole, 0.000014 mol per mol of GA) was used.

### Preparation of the Polymer PGA2800-200 (Run 7)

Poly(glycolic acid) PGA2800-200 was prepared similar to the procedure described for PGA2800-100, except that 0.2 g of stearic acid (SA; 200 ppm, 0.000704 mole, 0.000054 mol per mol of GA) was used.

### Preparation of the Polymer PGA2000-50 (Run 8)

Poly(glycolic acid) PGA2000-50 was prepared similar to the procedure described for PGA2000-100, except that 0.05 g of stearic acid (SA; 50 ppm, 0.000176 mole, 0.000014 mol per mol of GA) was used.

### Preparation of the Polymer PGA2000-200 (Run 9)

Poly(glycolic acid) PGA2000-200 was prepared similar to the procedure described for PGA2000-100, except that 2.00 g of stearic acid (SA; 200 ppm, 0.000704 mole, 0.000054 mol per mol of GA) was used.

### Preparation of the Polymer PGA2800-100-TMA (Run 10)

Poly(glycolic acid) PGA2800-100-TMA was prepared similar to the procedure described for PGA2800-100, except that 3.87 g of trimesic acid (TMA; 0.0186 mole, 0.0014 mol per mol of GA) was used in place of TCA.

Results are summarized in Table 1 below.

TABLE 1

| | | | | Low | High |
|---|---|---|---|---|---|
| | COOH/ | | | frequency³ | frequency⁴ |
| | OH¹ | X-link² | Time of | melt viscosity | melt viscosity |
| Run | (% mol) | (%) | SSP (hrs) | (Pa · s) | (Pa · s) |
| 1 | 0.00535 | 0.28 | 29.50 | 1633.80 | 302.30 |
| 2 | 0.00535 | 0.24 | 45.00 | 1068.70 | 262.90 |
| 3 | 0.00535 | 0.20 | 87.00 | 954.20 | 271.50 |
| 4 | 0.00535 | 0.16 | 141.00 | 230.70 | 126.10 |
| 5C | 0 | 0.28 | 86.00 | 804 | 203 |
| 6 | 0.00268 | 0.28 | 75.00 | 1565 | 285 |
| 7C | 0.01126 | 0.28 | 71.00 | 705 | 201 |
| 8 | 0.00268 | 0.20 | 79.00 | 1178 | 302 |
| 9C | 0.01071 | 0.20 | 82.00 | 139 | 87 |
| 10 | 0.00535 | 0.28 | 59.00 | 1495 | 270 |

¹molar ratio between COOH groups of stearic acid and OH groups of the glycolic acid;
²crosslinking density defined as percentage in moles of total polyol and polyacid equivalents with respect to equivalents of glycolic acid.
³low frequency melt viscosity means melt viscosity measured at a frequency rate of 1 sec⁻¹;
⁴high frequency melt viscosity means melt viscosity measured at a frequency rate of 100 sec⁻¹

As demonstrated by data above summarized, at a given crosslinking density, the time of solid state polymerization necessary for achieving a target melt viscosity of about 1000 Pa×sec at low frequency rate (or above) is significantly decreased by the addition of stearic acid (see e.g. comparison of Ex. 5C with Ex. 1, 6) within the claimed range, while higher amounts thereof, instead of facilitating chain growth through hydroxyl scavenging, rather act as end capper, hence inhibiting reaction (see Ex. 7C and 9C).

TABLE 2

| | | | | Low | High | |
|---|---|---|---|---|---|---|
| | | | | frequency | frequency | |
| | | | | melt | melt | |
| | | | | viscosity | viscosity | Shear |
| Polymer | G′ | G″ | G′/G″ | (Pa · s) | (Pa · s) | thinning |
| 1 | 650 | 1400 | 0.46 | 1633.80 | 302.30 | 5.40 |
| 2 | 290 | 1050 | 0.27 | 1068.70 | 262.90 | 6.12 |
| 3 | 223 | 954 | 0.23 | 954.20 | 271.50 | 3.51 |
| 4 | 26 | 190 | 0.14 | 230.70 | 126.10 | 1.82 |
| 5C | 220 | 800 | 0.28 | 804 | 203 | 3.96 |
| 6 | 700 | 1500 | 0.47 | 1565 | 285 | 5.50 |
| 7C | 180 | 700 | 0.26 | 705 | 201 | 3.51 |
| 8 | 321 | 1200 | 0.27 | 1178 | 302 | 3.90 |
| 9C | 30 | 140 | 0.21 | 139 | 87 | 1.60 |
| 10 | 595 | 1300 | 0.46 | 1495 | 270 | 5.54 |

Finally, a t-test analysis was carried out to find if the role of stearic acid is statistically significant. With 4 data points for non-stearic acid recipes and 19 data points for recipes containing stearic acid, the t-test has p<0.01, with the mean of the difference between the two recipes being about 60 hours. The confidence interval for the two sets of data is 95%, and by conventional criteria, the difference is considered to be extremely statistically significant.

1. A method for synthesizing a branched poly(hydroxyl acid) polymer comprising effecting polycondensation reaction of a monomer mixture comprising:
(i) at least one hydroxyacid (A), wherein hydroxyacid (A) is a hydroxyl acid having only one hydroxyl group and only one carboxylic acid group;
(ii) at least one polyol (H), wherein polyol (H) is a polyol comprising at least three hydroxyl groups and being free from carboxylic acid group;
(iii) at least one polyacid (O), wherein polyacid (O) is a polyacid comprising at least three carboxylic acid groups and being free from hydroxyl groups; and
(iv) at least one acid (C), wherein acid (C) is a carboxylic acid having one or two carboxylic acid groups and being free from hydroxyl group,
wherein the amount of acid (C) is such that the number of carboxylic acid groups thereof is comprised between 0.0001 to 0.010% with respect to the number of hydroxyl groups of hydroxyacid (A).

2. The method of claim 1 wherein said hydroxyacid (A) is selected from the group consisting of glycolic acid (GA), lactic acid (LA), and mixtures thereof.

3. The method claim 1, wherein polyol (H) is selected from the group consisting of:
triols;
tetraols;
polyols comprising 5 hydroxyl groups;
polyols comprising 6 hydroxyl groups; and
polyols comprising 8 hydroxyl groups.

4. The method of claim 1, wherein polyacid (O) comprises three or more carboxylic acid groups.

5. The method of claim 4, wherein polyacid (O) is selected from the group consisting of tricarballylic acid, 1,2,4,5-benzene tetracarboxylic acid and butane-1,2,3,4 tetracarboxylic acid.

6. The method of claim 1, wherein the amount of acid (C) is such that the number of carboxylic acid group of said acid (C) is of at least 0.0005% with respect to the number of hydroxyl groups of hydroxyacid (A) and/or at most 0.009% with respect to the number of hydroxyl groups of hydroxyacid (A).

7. The method of claim 1, wherein acid (C) is a long chain acid, wherein the total number of carbon atoms is at least 4.

8. The method of claim 7, wherein acid (C) is a monoacid selected from the group consisting of caprylic acid [CH₃(CH₂)₆COOH], capric acid [CH₃(CH₂)₈COOH], undecanoic acid [H₃C—(CH₂)₉—COOH], dodecanoic or lauric acid [H₃C—(CH₂)₁₀—COOH], tridecanoic acid [H₃C—(CH₂)₁₁—COOH], tetradecanoic or myristic acid [H₃C—(CH₂)₁₂—COOH], pentadecanoic acid [H₃C—(CH₂)₁₃—COOH], hexadecanoic or palmitic acid [H₃C—(CH₂)₁₄—COOH], octadecanoic or stearic acid [H₃C—(CH₂)₁₆—COOH], arachidic acid [H₃C—(CH₂)₁₈—COOH], and behenic acid [H₃C—(CH₂)₂₀—COOH].

9. The method of claim 7, wherein acid (C) is a dioacid selected from the group consisting of succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂—CH₂—COOH], pimelic acid [HOOC—(CH₂)₅—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecandioic acid [HOOC—(CH₂)₁₀—COOH], tetradecandioic acid [HOOC—(CH₂)₁₁—COOH], and octadecandioic acid [HOOC—(CH₂)₁₆—COOH].

10. The method according to claim 1, wherein said acid (C) is stearic acid.

11. The method according to claim 1, wherein a polycondensation catalyst is added to the monomer mixture in an amount of about 0.01 to 2 mol % with respect to the total moles of the monomers of the monomer mixtures.

12. The method of claim 11, wherein said polycondensation catalyst is selected from the group consisting of tin (II) chloride, stannous octoate, zinc acetate, zinc lactate and methanesulphonic acid.

13. The method according to claim 1, wherein an antioxidant is added to the monomer mixture.

14. The method according to claim 1, wherein the polycondensation reaction includes a first step of polymerization in the molten state and a second step of solid state polymerization (SSP).

15. A branched poly(hydroxyl acid) polymer comprising repeat units and moieties derived from
(i) at least one hydroxyacid (A), wherein hydroxyacid (A) is a hydroxyl acid having only one hydroxyl group and only one carboxylic acid group;
(ii) at least one polyol (H), wherein polyol (H) is a polyol comprising at least three hydroxyl groups and being free from carboxylic acid group;
(iii) at least one polyacid (O), wherein polyacid (O) is a polyacid comprising at least three carboxylic acid groups and being free from hydroxyl groups; and
(iv) at least one acid (C), wherein acid (C) is a carboxylic acid having one or two carboxylic acid groups and being free from hydroxyl group,
wherein the amount of moieties derived from said acid (C) is such that the number of carboxylic acid derivative groups thereof is comprised between 0.0001 to 0.01% with respect to the number of hydroxyl derivative groups of hydroxyacid (A).

16. The method claim 3, wherein said polyol (H) is selected from the group consisting of glycerol, trimethylolpropane, trimethylolbutane, 2,3-di(2′-hydroxyethyl)-cyclohexan-1-ol, hexane-1,2,6-triol, 1,1,1-tris(hydroxymethyl)ethane, 3-(2′-hydroxyethoxy)propane-1,2-diol, 3-(2′-hydroxypropoxy)-propane-1,2-diol, 2-(2′-hydroxyethoxy)-hexane-1,2-diol, 6-(2′hydroxypropoxy)-hexane-1,2-diol, 1,1,1-tris-[(2′-hydroxyethoxy)-methylethane, 1,1,1-tris-[(2′-hydroxypropoxy)-methyl-propane, 1,1,1-tris-(4′-hydroxyphenyl)ethane, 1,1,1-tris-(hydroxyphenyl)-propane, 1,1,5-tris-(hydroxyphenyl)-3-methylpentane, trimethylolpropane ethoxylate, trimethylolpropane propoxylate, tris(hydroxymethyl)aminomethane, diglycerol, di(trimethylolpropane), pentaerythritol, 1,1,4-tris-(dihydroxyphenyl)-butane, triglycerol, dipentaerythritol, and tripentaerythritol.

17. The method of claim 4, wherein said polyacid (O) comprises four carboxylic acid groups.

18. The method of claim 6, wherein the amount of acid (C) is such that the number of carboxylic acid group of said acid (C) is of at least 0.001% with respect to the number of hydroxyl groups of hydroxyacid (A) and/or at most 0.008% with respect to the number of hydroxyl groups of hydroxyacid (A).

19. The method of claim 7, wherein the total number of carbon atoms is at least 6.

20. The method according to claim 11, wherein the polycondensation catalyst is added to the monomer mixture in an amount of about 0.1 to 1 mol % with respect to the total moles of the monomers of the monomer mixtures.
